(19) United States
(12) Patent Application Publication
(10) Pub. No.: US 2020/0333748 A1
(43) Pub. Date: Oct. 22, 2020

(54) DEVICE FOR CONTROLLING AT LEAST ONE ELECTRONIC FUNCTION OF A PORTABLE OBJECT

(71) Applicant: ETA SA Manufacture Horlogere Suisse, Grenchen (CH)

(72) Inventors: Vittorio ZANESCO, Neuchatel (CH); Raphaël BALMER, Vieques (CH); Damien SCHMUTZ, Salavaux (CH); Pascal LAGORGETTE, Bienne (CH)

(73) Assignee: ETA SA Manufacture Horlogere Suisse, Grenchen (CH)

(21) Appl. No.: 16/762,983

(22) PCT Filed: Dec. 12, 2018
(86) PCT No.: PCT/EP2018/084617

§ 371 Date: May 11, 2020

(30) Foreign Application Priority Data
Dec. 27, 2017 (EP) 17210721.1

(51) Int. Cl. G04C 3/00; G04G 21/00

(52) U.S. Cl. CPC G04C 3/001; G04G 21/00

(57) ABSTRACT

A device for controlling at least one electronic function of a portable object, in particular a timepiece, includes a control stem capable of moving axially between at least a first and a second stable position, or between at least a stable position and an unstable position. The control device also includes an actuation element made from an electrically insulating material rigidly connected to the control stem, as well as at least one flexible electrical switching element provided to be mechanically actuated by the actuation element when the control stem is moved axially, said at least one flexible electrical switching element being capable of moving between a closing position in which said at least one flexible electrical switching element closes an electrical circuit of the control device, and an opening position in which said at least one flexible electrical switching element opens said electrical circuit.

### TECHNICAL FIELD OF THE INVENTION

The present invention relates to a device for controlling at least one electronic function of a portable object, in particular a timepiece. The invention also relates to such a timepiece including this control device.

### TECHNOLOGICAL BACKGROUND OF THE INVENTION

Portable objects such as a timepiece equipped with a device for controlling at least one electronic function implemented in such a portable object have been known for a long time.

These control devices generally comprise a control stem, the actuation of which allows to control the desired electronic function. For the correct execution of the desired electronic function, it is necessary to be able to detect the actuation of the control stem of the control device. Among the known solutions that allow to detect the actuation of a control stem, one widespread solution involves detecting the actuation of the control stem via the establishment of a galvanic contact by friction between a contact zone of this control stem and a corresponding electrical contact zone of an electrical circuit of this control device.

The solution described above has been known for a long time. It is simple to implement and not very costly. It has, however, certain disadvantages, examples of which include its lack of robustness and of reliability, which notably reduce its service life. Indeed, the repeated actuation of the control stem induces friction between the contact zone of this control stem and the corresponding contact zone of the electrical circuit. This repeated friction engenders a wear of the control stem and/or of the electrical circuit over time, which inevitably causes an alteration in the quality of the galvanic contact between these two elements. After a certain time, the introduction of a control signal via the control stem becomes more and more random, or even impossible, and most often the only thing left to do is to throw away the defective portable object.

To overcome this disadvantage, it is known in the prior art to coat the contact zone of the control stem and the contact zone of the electrical circuit which rub against one another with a layer of a material resistant to abrasion, for example a metal material such as cadmium.

However, the application of a layer of a material resistant to abrasion onto the corresponding contact zones of the control stem and of the electrical circuit involves long and complex operations, which leads to an increase in the manufacturing costs of such control devices and, consequently, of the portable devices such as timepieces into which these portable devices are integrated. This is difficult to accept from an economic point of view, given that the portable objects equipped with such control devices are often cheap portable objects for which the production cost of the various components is a crucial factor.

Moreover, it is routine for the materials that have good properties of resistance to abrasion to be substances dangerous to humans, so that their use is often incompatible with small portable objects intended to be worn in contact with the skin of the users, and which can even be opened by the latter.

### SUMMARY OF THE INVENTION

The goal of the present invention is to overcome the problems mentioned above as well as yet others by providing a robust and reliable control device comprising an actuation element that is carried by a control stem of the device, this actuation element being capable of cooperating via friction with an electrically conductive switching element in order to force this switching element to establish a galvanic contact with a contact pad of an electrical circuit with a view to ensuring a closing of this electrical circuit.

For this purpose, the object of the present invention is a device for controlling at least one electronic function of a portable object, in particular a timepiece, comprising a control stem capable of moving axially between at least a first and a second stable position, or between at least a first stable position and a second unstable position, the control device also comprising an actuation element rigidly connected to the control stem, as well as at least one flexible electrical switching element provided to be mechanically actuated by the actuation element when the control stem is moved axially, said at least one flexible electrical switching element being capable of moving between a closing position in which said at least one flexible electrical switching element closes an electrical circuit of the control device, and an opening position in which said at least one flexible electrical switching element opens said electrical circuit.

In other embodiments:
the actuation element comprises a position-indexing zone including a cam profile provided to participate in the indexing of the stable and unstable positions into which the control stem is brought during an axial movement;
the control device comprises a positioning spring arranged to cooperate with the cam profile defined in the position-indexing zone of the actuation element in order to define each stable and unstable position of the control stem;
the control device comprises at least one electrical contact stud provided to cooperate with said at least one flexible electrical switching element when the latter is moved into a closing position;
said at least one electrical contact stud comprises an end that is connected to a contact pad of the electrical circuit of the control device;
the control device comprises a mechanical fastening stud connecting said at least one flexible electrical switching element in a fixed manner to the electrical circuit of the control device;
the cam profile is formed by at least one hollow provided to cooperate with the positioning spring of the control device in order to define the stable position of the control stem, and/or a slope provided to cooperate with the positioning spring in order to define the unstable position of the control stem;
said at least one flexible electrical switching element is made in one piece and has the shape of a V with two branches that each comprise an electrical contact zone of said flexible electrical switching element;
the control device includes two distinct flexible electrical switching elements that each comprise an electrical contact zone;
each flexible electrical switching element is capable of cooperating with a mechanical contact zone of the actuation element in order to place the corresponding electrical contact zone in contact with the corresponding electrical contact stud during the movement of this flexible electrical switching element into the closing position.

The invention also relates to a portable object, in particular a timepiece, comprising at least one such control device.

### BRIEF DESCRIPTION OF THE DRAWINGS

Other features and advantages of the present invention will be clearer from the detailed description that follows of a plurality of embodiments, these embodiments being given for purely illustrative and non-limiting purposes in relation to the appended drawings in which:

FIG. 1 is a perspective view of a device for controlling at least one electronic function of a portable object according to a first embodiment;

FIG. 2 is a transparent top view of a second embodiment of a device for controlling at least one electronic function of a portable object;

FIG. 3 is a transparent perspective view of the control device illustrated in FIG. 2;

FIG. 4 is a perspective view of a positioning spring of the control device according to the first and second embodiments, and

FIG. 5 is a schematic view of the portable object, here a timepiece, including the control device according to the first and second embodiments.

### DETAILED DESCRIPTION OF AN EMBODIMENT OF THE INVENTION

The present invention is based on the general inventive idea consisting in providing a device for controlling at least one electronic function of a portable object with small dimensions, for example a wristwatch, in which the zone in which an electrical switching element is mechanically actuated is distinct from the zone in which the electrical switching element makes electrical contact for the activation of the electronic function. As a result of these features, the zone of electrical contact is protected against any risk of wear related to the friction engendered in the mechanical contact zone.

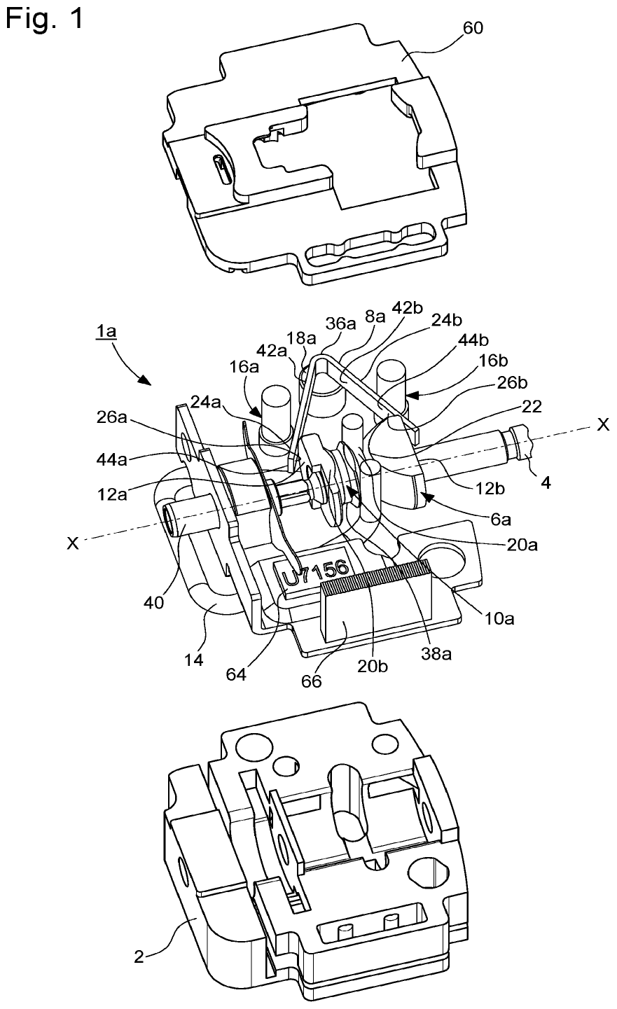

Designated overall by the general numerical reference 1a, a first embodiment of the control device according to the invention is illustrated in FIG. 1. This control device 1a, arranged to control at least one electronic function of a portable object 54 such as, in a non-limiting manner, a timepiece, comprises a lower frame 2 that acts as a cradle for a control stem 4. This control stem 4 is capable of moving axially from back to front and from front to back to control at least one electronic function of the portable object 54 in a robust and reliable manner.

In the following description, the back to front direction is a rectilinear direction that extends from an actuation crown 50 located outside the portable object 54 towards the inside of this portable object 54 in which the control device 1a, 1b is housed. This direction extends horizontally along the longitudinal axis of symmetry X-X of the control stem 4, perpendicularly to a middle 56 of the portable object 54. Thus, the control stem 4 is pushed from the back towards the front, and is pulled from the front towards the back. Moreover, the vertical direction z is a direction that extends perpendicularly to a bottom 58 of the portable object 54.

To allow the control of at least one electronic function of the portable object 54, the control device 1a comprises first of all an actuation element 6a which can be chosen to be made in one piece with the control stem 4 or fastened onto the latter. This actuation element 6a has at least one mechanical contact zone 12a, 12b by which it is in contact with an electrically conductive electrical switching element 8a. This actuation element 6a is arranged to actuate the electrical switching element 8a and allow the latter to establish a galvanic contact between an electrical contact zone of this electrical switching element 8a and a contact stud of an electrical circuit in order to ensure the closing of this electrical circuit. Thus, in the control device 1a according to the invention, the zone 12a, 12b of mechanical contact between the actuation element 6a and the electrical switching element 8a, and the zone of electrical contact between the electrical switching element 8a and the contact stud of the electrical circuit are two distinct zones, so that the repeated friction between the actuation element 6a and the electrical switching element 8a does not have any influence on the quality of the galvanic contact between the electrical contact zone and the contact stud of the electrical circuit.

As already mentioned above, the control device 1a illustrated in FIG. 1 is intended to allow the control of at least one electronic function of the portable object 54 which is an object with small dimensions such as a timepiece, in particular a wristwatch. The lower frame 2 of this control device 1a, for example made from an electrically insulating material such as injected plastic, acts as a cradle for the control stem 4 which preferably but not in a limiting way has an elongated and substantially cylindrical shape, and which has a longitudinal axis of symmetry X-X. This control stem 4 is arranged to slide from front to back and from back to front along its longitudinal axis of symmetry X-X, and/or to rotate about this same longitudinal axis of symmetry X-X in the clockwise and anti-clockwise direction.

More precisely, the control stem 4 comprises a rear end 46 which is located outside of the portable object 54 once the control device 1a has been installed in the portable object 54, and which is provided to receive an actuation crown 50. This control stem 4 also comprises a front end 48 which is located inside the portable object 54 once the control device 1a is housed inside the latter. The control stem 4 is also equipped with a smooth bearing 40 which, via cooperation with a corresponding receiving surface of the lower frame 2, ensures the support and the axial guiding of this control stem 4. It is noted that to allow the passage of the control stem 4 and the installation of the control device 1a in the portable object 54, a hole 52 is made in the middle of the portable object 54.

In this control device 1a, the lower frame 2 forms a cradle which is provided to receive the control stem 4 of the control device 1a. In the control device 1a, the control stem 4 has a preferably elongated and substantially cylindrical shape and extends along its longitudinal axis of symmetry X-X. The front end 48 of the control stem 4 has a for example square cross-section 12 that is capable of receiving the smooth bearing 40.

The actuation element 6a which can be made in one piece with the control stem 4 or be rigidly mounted onto this control stem 4 is capable of being driven in a movement of translation or of pivoting relative to the lower frame 2 when the control stem 4 is moved axially, or pivoted, respectfully, relative to this lower frame 2. In the case in which the actuation element 6a is a part added onto the control stem 4, it is preferably made from an electrically insulating material, that is to say a material that allows to prevent the passage of an electrical current into the control stem 4 onto which it is mounted when this actuation element 6a is placed in contact with an electrically conductive electrical component. For example, this actuation element 6a can be made of plastic.

Located in the lower frame 2 inside the control device 1a, the actuation element 6a is as a preferred but non-limiting example in the form of a ring having a circular transverse cross-section. This actuation element 6a comprises a peripheral wall and front and rear faces. The peripheral wall comprises a position-indexing zone 10a provided with a cam profile for example consisting of two hollows 20a and 20b separated from one another by a crest 38a which protrudes, the hollow 20a being extended by a sloped profile 22, for example of the truncated-cone type, which flares out towards the rear end 46 of the control stem 4. The two hollows 20a and 20b are for example circular grooves centred on the longitudinal axis of symmetry X-X of the control stem 4. It is noted that this cam profile comprises as many hollows as the number of stable positions in which the control stem 4 can be indexed in the control device 1a. Likewise, the cam profile comprises a number of slopes identical to the number of unstable positions into which the control stem 4 can be brought.

The cam profile formed by one or more hollows 20a, 20b and/or slope 22 of the position-indexing zone 10a of the actuation element 6a allows, via cooperation with the ends 34 of the rods 28 of a positioning spring 14, to define the stable and/or unstable position(s) in which the control stem 4 is capable of being located when the user moves it axially from back to front or from front to back.

More precisely, the positioning spring 14 has the overall shape of a U with two arms 30 that extend in a horizontal plane and which are connected to each other by a base 32. At their free end, the two arms 30 are extended by two substantially rectilinear upright rods 28. The positioning spring 14 is intended to be mounted in the control device 1a via the bottom of the lower frame 2, so that the ends 34 of the rods 28 protrude at the cam profile of the position-indexing zone 10a of the actuation element 6a.

The front and/or rear faces of the actuation element 6a define the mechanical contact zones 12a and 12b by which the actuation element 6a is capable of cooperating with the electrical switching element 8a of the control device 1a. More precisely, this electrical switching element 8a is a component of the “switch” type of an electrical circuit of the control device 1a. This electrical switching element 8a is indeed capable of being mechanically controlled by the actuation element 6a when the control stem 4 is moved axially from back to front or from front to back in order to be brought into one of its stable or unstable positions. When this electrical switching element 8a is mechanically controlled by the actuation element 6a, it deforms elastically and moves alternatingly from an open position to a closed position of the electrical circuit of the control device 1a. For this purpose, this electrical switching element 8a comprises:
a linking part 36a which connects it preferably in a fixed and/or rigid manner to this electrical circuit via a fastening stud 18a of the control device 1a;
at least one, and in the example shown, two electrical contact zones 24a, 24b defined in the outer faces of this electrical switching element 8a and provided to come in contact with a first and a second contract stud 16a, 16b of the electrical circuit when this electrical switching element 8a is moved into the position for closing the electrical circuit, and
at least one, and in the example shown, two mechanical contact zones 26a, 26b defined in the inner faces of this electrical switching element 8a and provided to cooperate with the mechanical contact zones 12a, 12b formed by the front and/or rear faces of the actuation element 6a, 6b.

It is noted that the electrical switching element 8a is for example a metal spring strip in the shape of a V as illustrated in FIG. 1.

It is understood that the fastening stud 18a and the first and second contact studs 16a and 16b are all three conductors of electricity and are arranged in the lower frame 2 of the control device 1a, and that they each comprise an end that is connected to a contact pad provided on the surface of a printed circuit, for example a sheet of a flexible printed circuit (not shown), above which the control device 1a is disposed. Advantageously, the electrical circuit which allows to connect the fastening stud 18a and the two contact studs 16a, 16b to each other is structured on the sheet of flexible printed circuit. It is also noted that the fastening stud 18a and the contact studs 16a, 16b can be helical contact springs, spring strips or other. The electrical circuit also comprises all the necessary electronic components such as a microcontroller 64 and an electrical connector 66 for example of the ZEBRA® type for the execution of the desired electronic function.

The control device 1a comprises an upper frame 60 which is provided to cover the lower frame 2. The meeting of these two lower 2 and upper 60 frames which each have for example an overall parallelepipedic shape defines the outer geometry of the control device 1a. These two frames 2, 60 comprise the housings and surfaces adapted to receiving the component elements of the present control device 1a.

In the first embodiment described above and illustrated in FIG. 1, the control device 1a is provided with a single electrical switching element 8a. This electrical switching element 8a is made in one piece and has the shape substantially of a V with first and second arms 44a, 44b connected to each other by a linking part 36a. This electrical switching element 8a comprises a linking part 36a at which these arms 44a, 44b are connected to each other and which allows to ensure the fastening of the electrical switching element 8a onto the fastening stud 18a for example by gluing, welding or interlocking. The outer face 42a of the arms 44a, 44b of the V forms the first and second electrical contact zones 24a, 24b of the electrical switching element 8a, while the inner faces 42b of the free ends of the arms 44a, 44b of the V define the mechanical contact zones 26a and 26b provided to cooperate with the mechanical contact zones 12a, 12b of the actuation element 6a. It is understood that the arms 44a, 44b of the V of the electrical switching element 8a are maintained distant from each other by the actuation element 6a against the elastic return force of the spring material from which the electrical switching element 8a is made. Consequently, when the control stem 4 is for example pulled from front to back, the electrical contact between the first electrical contact zone 24a and the first contact stud 16a is broken, while the electrical contact between the second electrical contact zone 24b and the second contact stud 16b is established. Thus, the first electrical circuit between the first contact stud 16a and the fastening stud 18a is open, while the second electrical circuit between the fastening stud 18a and the second contact stud 16b is closed. The reverse of that which has just been described occurs when the control stem 4 is pushed from back to front.

It will be understood upon reading that which follows that the cooperation between the position-indexing zone 10a of the actuation element 6a and the stems 28 of the positioning spring 14 allow to index the position of the control stem 4 in a first stable position T1 from which this control stem 4 can be pushed towards the front into an unstable position T0 or pulled towards the back into a second stable position T2, these three unstable T0 and stable T1 and T2 positions each corresponding to the introduction of a distinct electrical control signal.

More precisely, in FIG. 1, the control stem 4 is in its stable position T1 from which it will be understood that it can be pushed towards the front into its unstable position T0, or be pulled towards the back into its stable position T2. Thus, the first stable position T1 of the control stem 4 corresponds to the position in which the ends 34 of the rods 28 of the positioning spring 14 protrude into the first hollow 20a of the position-indexing zone 10a defined in the actuation element 6a. In this first stable position T1, the electrical switching element 8a is in its rest position in which its mechanical contact zones 26a, 26b are in contact with and maintained distant from one another by the actuation element 6a, while its first and second electrical contact zones 24a and 24b are not in contact with the first and second contact studs 16a and 16b.

From this first stable position T1, the control stem 4 can be pushed forward into an unstable position T0. During this movement, the ends 34 of the rods 28 of the positioning spring 14 exit the first hollow 20a and follow the sloped profile 22 which progressively moves away from the longitudinal axis of symmetry X-X of the control stem 4. To force the ends 34 of the rods 28 of the positioning spring 14 to exit the first hollow 20a and move onto this sloped profile 22 while moving away from one another, the user must thus overcome a meaningful resisting stress. This resisting stress results from the fact that by following the sloped profile 22, the rods 28 of the positioning spring 14 move away from one another from their rest position and tend to desire to once again move closer to one another under the effect of their elastic return force opposed to the pushing force exerted by the user on the control stem 4. When he moves the control stem 4 from its stable position T1 towards its unstable position T0, the user must also overcome the resisting stress opposed by the electrical switching element 8a, the free end of the first arm 44a of which that bears on the first mechanical contact zone 12a of the actuation element 6a moves slightly away from its rest position when the user pushes on the control stem 4, and tends to once again desire to reoccupy this rest position under the effect of its elastic return force. In this unstable position T0 of the control stem 4, the first electrical contact zone 24a of the electrical switching element 8a is in contact with the first contact stud 16a, and thus closes the electrical circuit between this first contact stud 16a and the fastening stud 18a. The electrical current thus passes through the electrical switching element 8a from the first contact stud 16a to the fastening stud 18a, which allows to detect the position of closing the corresponding electrical circuit.

As soon as the user releases the pressure on the control stem 4, the rods 28 of the positioning spring 14 spontaneously go back down along the sloped profile 22, their ends 34 again being housed in the first hollow 20a of the position-indexing zone 10a of the actuation element 6a, forcing the control stem 4 to go back to its stable position T1. The first arm 44a of the electrical switching element 8a also goes back to its rest position and thus participates in the return movement of the control stem 4 into its stable position T1. The control stem 4 is thus automatically returned from its unstable position T0 to its first stable position T1.

From the stable position T1, it is possible to pull the control stem 4 backward into a second stable position T2. During this movement, the ends 34 of the rods 28 of the positioning spring 14 go while being elastically deformed from the first hollow 20a to the second hollow 20b by passing over the crest 38a separating them. At the same time, the electrical switching element 8a, the free end of the second arm 44b of which bears on the second mechanical contact zone 12b of the actuation element 6a, moves slightly away from its rest position when the user pulls on the control stem 4, and tends to once again desire to go back to this rest position under the effect of its elastic return force. In this stable position T2 of the control stem 4, the second electrical contact zone 24b of the electrical switching element 8a is in contact with the second contact stud 16b, and thus closes the electrical circuit between the fastening stud 18a and this second contact stud 16b. The electrical current thus passes through the electrical switching element 8a from the fastening stud 18a to the second contact stud 16b, which allows to detect the position of closing the corresponding electrical circuit.

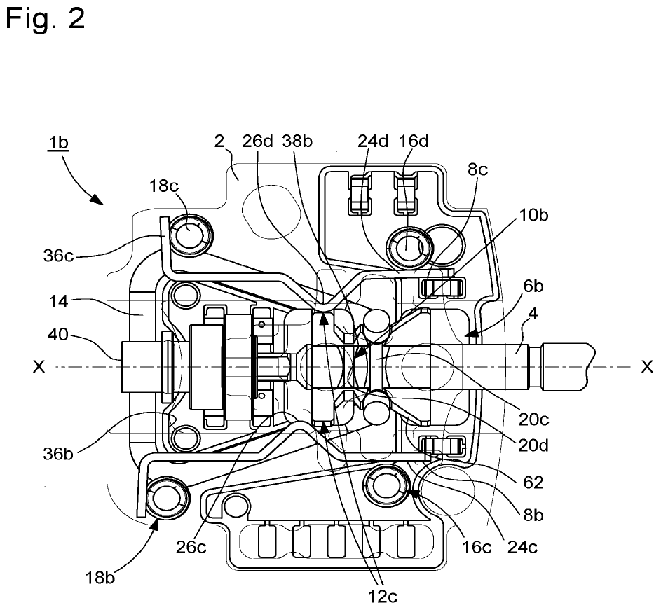

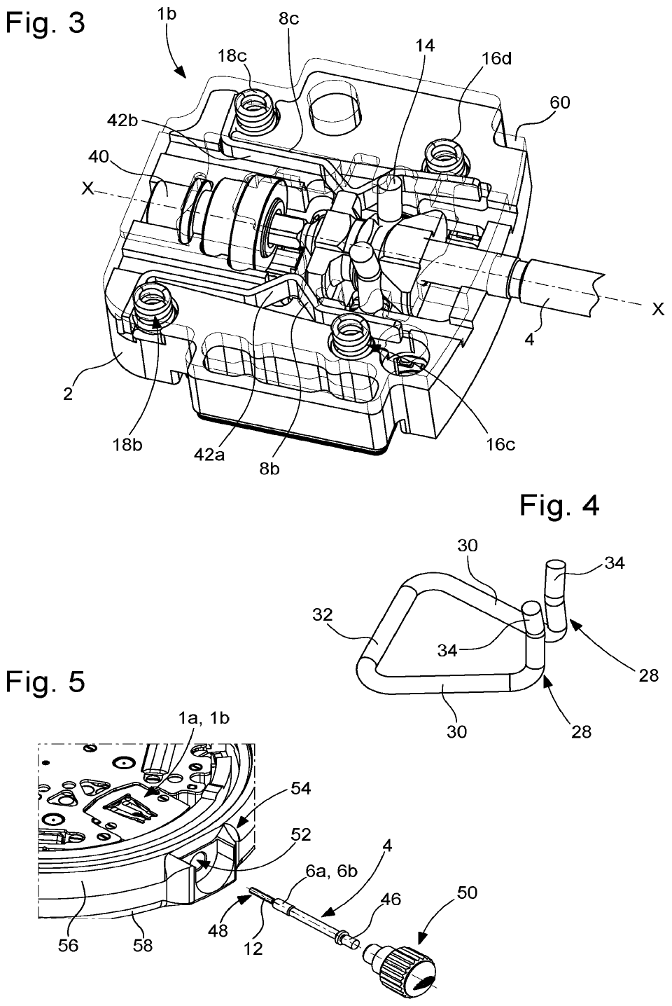

Designated as a whole by the general numerical reference 1b, a second embodiment of the control device according to the invention is illustrated in FIGS. 2 and 3. This control device 1b includes distinct first and second electrical switching elements 8b and 8c. The first end of each of these first and second electrical switching elements 8b and 8c comprises in its outer face 42a a first linking part 36b and a second linking part 36c, respectively, allowing to ensure the fastening, in particular by gluing, welding or interlocking, of these two electrical switching elements 8b, 8c onto a corresponding first and second fastening stud 18b, 18c of the control device 1b. As for the second end of the electrical switching elements 8b and 8c, it comprises a first and a second electrical contact zone 24c, 24d, respectively, arranged in the outer face 42a of the electrical switching elements 8b, 8c.

These first and second electrical switching elements 8b, 8c also comprise, between their first and second ends, a deformed part, for example a fold in the shape of a V, that forms in their inner face 42b a first and a second mechanical contact zone 26c, 26d, respectively. Thus, in the control device 1b according to the invention, the mechanical contact zones 26c, 26d between the actuation element 6b and the electrical switching elements 8b and 8c, and the electrical contact zones 24c, 24d between the electrical switching elements 8c and 8d and the contact studs 16c and 16d are zones distinct from one another, so that the repeated friction between the actuation element 6b and the electrical switching elements 8b and 8c does not have any influence on the quality of the galvanic contact between the electrical switching elements 8b, 8c and the contact studs 16c, 16d. It is also observed that the mechanical contact zones 26c and 26d of the first and second electrical switching elements 8b and 8c are not facing one another, so that when the actuation element 6b activates one of these electrical switching elements 8b, 8c, this does not necessarily cause the activation of the other electrical switching element.

In the control device 1b, the position-indexing zone 10b of the actuation element 6b comprises first and second hollows 20c and 20d separated by a crest 38b. The hollow 20c is continued by a sloped profile 62 that flares out towards the rear end of the control stem 4.

In addition in this control device 1b, the mechanical contact zone 12c of the actuation element 6b that must cooperate with the mechanical contact zones 26c, 26d of the first and second flexible electrical switching elements 8b, 8c during the axial movement of the control stem 4 is located in the front and rear faces as well as in a part of the peripheral wall of the actuation element 6b. It is noted that the cooperation between the mechanical contact zone 12c of the actuation element 6b and the mechanical contact zones 26c, 26b engenders a substantially pivoting movement of the first and second flexible electrical switching elements 8b, 8c about the stationary points formed by the fastening studs 18b, 18c and, in particular, the displacement of the electrical contact zones 24c, 24d defined in these flexible electrical switching element electrical switching elements 8b, 8c.

The control device 1b comprises two electrical circuits. The first of these electrical circuits consists in particular of the contact stud 16c and the fastening stud 18b, as well as the first electrical switching element 8b. As for the second electrical circuit, it consists in particular of the contact stud 16d, the fastening stud 18c, and the electrical switching element 8c.

It will be shown below that the cooperation between the position-indexing zone 10b of the actuation element 6b and the positioning spring 14 allows to index the position of the control stem 4 between stable T1 and T2 and unstable T0 positions.

In the second embodiment of the control device 1b illustrated in FIGS. 2 and 3, the control stem 4 can be pulled from its first stable position T1 towards the back into a second stable position T2 or pushed towards the front into a third unstable position T0. These three positions T0, T1 and T2 of the control stem 4 are indexed by cooperation between the position-indexing zone 10b and the positioning spring 14. More precisely, the stable position T1 corresponds to the position in which the ends 34 of the rods 28 of the positioning spring 14 protrude into the first hollow 20c of the position-indexing zone 10b defined in the actuation element 6b. In this position, the rods 28 of the positioning spring 14 as well as the first flexible electrical switching element 8b are in their rest position, that is to say a position in which they are not subjected to a constraining force. In this stable position T1, the first flexible electrical switching element 8b of the control device 1b occupies a position in which the first electrical circuit is open. In this position in which the first electrical circuit is open, the electrical contact zone 24c defined on the outer face 42a of the free end of this first flexible electrical switching element 8b is not in contact with the third corresponding contact stud 16c of the control device 1b. However, in the stable position T1 of the control stem 4, the second flexible electrical switching element 8c of the control device 1b occupies a position in which the second electrical circuit is closed. In this position in which the second electrical circuit is closed, the electrical contact zone 24d defined on the outer face 42a of the free end of this second flexible electrical switching element 8c is in contact with the fourth corresponding contact stud 16d of the control device 1b. Thus, the electrical current passes through the second flexible electrical switching element 8c, which allows to detect the closed position of the electrical contact between this second flexible electrical switching element 8c and the second contact stud 16d.

From the first stable position T1, it is possible to pull the control stem 4 backward into a second stable position T2. During this movement, the ends 34 of the rods 28 of the positioning spring 14 go while being elastically deformed from the first hollow 20c to the second hollow 20d by passing over the crest 38b separating them. Likewise, during this movement, the mechanical contact zone 12c of the actuation element 6b on which the second flexible electrical switching element 8c bears moves while rubbing against this flexible electrical switching element 8c until a point at which this second flexible electrical switching element 8c is no longer in contact with the actuation element 6b and goes back to its rest position under the effect of the elastic return forces. In this stable position T2 of the control stem 4, the second flexible electrical switching element 8c of the control device 1b occupies a position in which the second electrical circuit is open. In this position in which the second electrical circuit is open, the electrical contact zone 24d defined on the outer face 42a of the free end of this second flexible electrical switching element 8c is not in contact with the fourth corresponding contact stud 16d of the control device 1b. Moreover, in the second stable position T2 of the control stem 4, the position of the first flexible electrical switching element 8b remains unchanged. In this second stable position T2, the first flexible electrical switching element 8b of the control device 1b still occupies a position in which the first electrical circuit is open and the electrical contact zone 24c defined on the outer face 42a of the free end of this first flexible electrical switching element 8b is not in contact with the third corresponding contact stud 16c of the control device 1b.

From the first stable position T1, the control stem 4 can be pushed forward into a third unstable position T0. During this movement, the ends 34 of the rods 28 of the positioning spring 14 exit the first hollow 20c and follow the sloped profile 62, for example of the truncated-cone type, which progressively moves away from the longitudinal axis of symmetry X-X of the control stem 4. To force the ends 34 of the rods 28 of the positioning spring 14 to exit the first hollow 20c and move onto this sloped profile 62 while moving away from one another, the user must thus overcome a meaningful resisting stress. This resisting stress results from the fact that by following the sloped profile 62, the rods 28 of the positioning spring 14 move away from one another from their rest position and tend to desire to once again move closer to one another under the effect of their elastic return force opposed to the pushing force exerted by the user on the control stem 4. As soon as the user releases the pressure on the control stem 4, the rods 28 of the positioning spring 14 spontaneously go back down along the sloped profile 62, their ends 34 again being housed in the first hollow 20c of the position-indexing zone 10b of the actuation element 6b, forcing the control stem 4 to go back to its stable position T1. The control stem 4 is thus automatically returned from its unstable position T0 to its first stable position T1.

Likewise, during this movement, the mechanical contact zone 12c of the actuation element 6b moves while rubbing against the mechanical contact zone 26d of the second flexible electrical switching element 8c which bears on this mechanical contact zone 12c of the actuation element 6b, until a point at which this second flexible electrical switching element 8b is no longer in contact with the actuation element 6b and goes back to its rest position under the effect of the elastic return forces. In this unstable position T0 of the control stem 4, the second flexible electrical switching element 8c of the control device 1b occupies a position in which the second electrical circuit is open. In this position in which the second electrical circuit is open, the electrical contact zone 24d defined on the outer face 42a of the free end of this second flexible electrical switching element 8c is not in contact with the fourth corresponding contact stud 16d of the control device 1b. As for the first flexible electrical switching element 8b, it moves from its rest position and abuts against the third contact stud 16c at its electrical contact zone 24c when the ends 34 of the rod 28 of the positioning spring 14 are on the sloped profile 22. It is noted that, during this movement, the mechanical contact zone 12c of the actuation element 6b moves while rubbing against the mechanical contact zone 26c of the first flexible electrical switching element 8b. This movement engenders a deformation of this first flexible electrical switching element 8b sufficient to allow placement of its electrical contact zone 24c in contact with the third contact stud 16c. Thus, when the control stem 4 arrives in its unstable position T0, only the first flexible electrical switching element 8b is brought into a position of closing the first electrical circuit in which its electrical contact zone 24c defined on its outer face 42a is in contact with the third contact stud 16c of the control device 1b. Thus, the electrical current passes through the first flexible electrical switching element 8b, which allows to detect the closed position of the electrical contact between this first flexible electrical switching element 8b and the third contact stud 16c.

In this second embodiment, three electronic functions of the portable object 54 can thus be controlled by the control device 1b according to whether the control stem 4 is brought into one or the other of its three unstable T0 or stable T1, T2 positions:
the first stable position T1 in which only the second flexible electrical switching element 8c is in contact with the corresponding contact stud 16d at its electrical contact zone 24d, so that the second electrical circuit is in a closed or switched state;
the second stable position T2 in which none of the first and second flexible actuation elements 8b, 8c are in contact with the third or the fourth corresponding contact stud 16c, 16d, so that each of the first and second electrical circuits is in an open or non-switched state;
the unstable position T0 in which only the first flexible electrical switching element 8b is in contact with the corresponding contact stud 16c at its electrical contact zone 24c, so that the first electrical circuit is in a closed or switched state.

In an alternative of this second embodiment, an additional function of the portable object 54 can be controlled by the control device 1b when the control stem 4 is in a new stable or unstable position in which the first and second flexible electrical switching elements 8b, 8c are in contact with the third and fourth contact studs 16c, 16d, respectively, so that first and second electrical circuits are simultaneously in a closed or switched state.

It goes without saying that the present invention is not limited to the embodiments that have just been described, and that various simple modifications and alternatives are possible for a person skilled in the art without going beyond the context of the invention as defined by the appended claims. It is noted in particular that the actuation element and the control stem can both be electrically insulating, or the actuation element is electrically insulating, in which case the control stem can be insulating or electrically conductive, or the actuation element is electrically conductive, in which case the control stem does not conduct electricity.

### NOMENCLATURE

1a, 1b. Control device
2. Frame
4. Control stem
6a, 6b. Actuation element
8a, 8b, 8c, 8d. Flexible electrical switching element
10a, 10b. Position-indexing zones
12a, 12b, 12c. Mechanical contact zones
14. Positioning spring
16a, 16b, 16c, 16d. Contact studs
18a, 18b, 18c. Fastening studs
20a, 20b, 20c, 20d. Hollows
22. Sloped profile
24a, 24b, 24c, 24d. Electrical contact zones
26a, 26b, 26c, 26d. Mechanical contact zones
28. Rod
30. Arm
32. Base
34. Ends of the rods
36a, 36b, 36c. Linking parts
38a, 38b, 38c. Crests
40. Smooth bearing
42a. outer face
42b. inner face
44a, 44b. First and second arms
46. Rear end
48. Front end
50. Actuation crown
52. Hole
54. Portable object
56. Middle
58. Bottom
60. Upper frame
62. Sloped profile
64. Microcontroller
66. Electrical connector

1-9. (canceled)

10. A device for controlling at least one electronic function of a portable object, in particular a timepiece, comprising a control stem capable of moving axially between at least a first and a second stable position, or between at least a stable position and an unstable position, the control device also comprising an actuation element made from an electrically insulating material rigidly connected to the control stem, as well as at least one flexible electrical switching element provided to be mechanically actuated by the actuation element when the control stem is moved axially, said at least one flexible electrical switching element being capable of moving between a closing position in which said at least one flexible electrical switching element closes an electrical circuit of the control device and an opening position in which said at least one flexible electrical switching element opens said electrical circuit, at least one electrical contact stud being provided to cooperate with said at least one flexible electrical switching element when said at least one flexible electrical switching element is moved into the closing position, said at least one flexible electrical switching element being made in one piece and having the shape of a V with two branches that each comprise an electrical contact zone of said flexible electrical switching element.

11. The control device according to claim 10, wherein the actuation element comprises a position-indexing zone including a cam profile provided to participate in the indexing of the stable and unstable positions into which the control stem is brought during an axial movement.

12. The control device according to claim 11, comprising a positioning spring arranged to cooperate with the cam profile defined in the position-indexing zone of the actuation element in order to define each stable and unstable position of the control stem.

13. The control device according to claim 12, wherein the cam profile is formed by at least one of at least one hollow provided to cooperate with the positioning spring of the control device in order to define the stable position of the control stem and a slope provided to cooperate with the positioning spring in order to define the unstable position of the control stem.

14. The control device according to claim 12, comprising a mechanical fastening stud connecting said at least one flexible electrical switching element in a fixed manner to the electrical circuit of the control device.

15. The control device according to claim 14, wherein the cam profile is formed by at least one of at least one hollow provided to cooperate with the positioning spring of the control device in order to define the stable position of the control stem and a slope provided to cooperate with the positioning spring in order to define the unstable position of the control stem.

16. The control device according to claim 12, wherein said at least one electrical contact stud comprises an end that is connected to a contact pad of the electrical circuit of the control device.

17. The control device to claim 16, wherein the cam profile is formed by at least one of at least one hollow provided to cooperate with the positioning spring of the control device in order to define the stable position of the control stem and a slope provided to cooperate with the positioning spring in order to define the unstable position of the control stem.

18. The control device according to claim 16, comprising a mechanical fastening stud connecting said at least one flexible electrical switching element in a fixed manner to the electrical circuit of the control device.

19. The control device according to claim 18, wherein the cam profile is formed by at least one of at least one hollow provided to cooperate with the positioning spring of the control device in order to define the stable position of the control stem and a slope provided to cooperate with the positioning spring in order to define the unstable position of the control stem.

20. The control device according to claim 11, comprising a mechanical fastening stud connecting said at least one flexible electrical switching element in a fixed manner to the electrical circuit of the control device.

21. The control device according to claim 20, wherein the cam profile is formed by at least one of at least one hollow provided to cooperate with the positioning spring of the control device in order to define the stable position of the control stem and a slope provided to cooperate with the positioning spring in order to define the unstable position of the control stem.

22. The control device according to claim 11, wherein said at least one electrical contact stud comprises an end that is connected to a contact pad of the electrical circuit of the control device.

23. The control device according to claim 22, wherein the cam profile is formed by at least one of at least one hollow provided to cooperate with the positioning spring of the control device in order to define the stable position of the control stem and a slope provided to cooperate with the positioning spring in order to define the unstable position of the control stem.

24. The control device according to claim 22, comprising a mechanical fastening stud connecting said at least one flexible electrical switching element in a fixed manner to the electrical circuit of the control device.

25. The control device according to claim 24, wherein the cam profile is formed by at least one of at least one hollow provided to cooperate with the positioning spring of the control device in order to define the stable position of the control stem and a slope provided to cooperate with the positioning spring in order to define the unstable position of the control stem.

26. The control device according to claim 10, wherein said at least one electrical contact stud comprises an end that is connected to a contact pad of the electrical circuit of the control device.

27. The control device according to claim 26, wherein the cam profile is formed by at least one of at least one hollow provided to cooperate with the positioning spring of the control device in order to define the stable position of the control stem and a slope provided to cooperate with the positioning spring in order to define the unstable position of the control stem.

28. The control device according to claim 26, comprising a mechanical fastening stud connecting said at least one flexible electrical switching element in a fixed manner to the electrical circuit of the control device.

29. The control device according to claim 28, wherein the cam profile is formed by at least one of at least one hollow provided to cooperate with the positioning spring of the control device in order to define the stable position of the control stem and a slope provided to cooperate with the positioning spring in order to define the unstable position of the control stem.

30. The control device according to claim 10, comprising a mechanical fastening stud connecting said at least one flexible electrical switching element in a fixed manner to the electrical circuit of the control device.

31. The control device according to claim 30, wherein the cam profile is formed by at least one of at least one hollow provided to cooperate with the positioning spring of the control device in order to define the stable position of the control stem and a slope provided to cooperate with the positioning spring in order to define the unstable position of the control stem.

32. The control device according to claim 10, comprising two distinct flexible electrical switching elements that each comprise an electrical contact zone.

33. The control device according to claim 32, wherein each flexible electrical switching element is configured to cooperate with a mechanical contact zone of the actuation element in order to place the corresponding electrical contact zone in contact with the corresponding electrical contact stud during the movement of this flexible electrical switching element into the closing position.

34. A portable object, in particular a timepiece, comprising at least one control device according to claim 10.
